(19) United States
(12) Patent Application Publication
(10) Pub. No.: US 2013/0119781 A1
(43) Pub. Date: May 16, 2013

(54) RESONANCE TYPE NON-CONTACT POWER SUPPLY SYSTEM

(71) Applicants: Kazuyoshi Takada, Kariya-shi (JP); Shimpei Sakoda, Kariya-shi (JP); Sadanori Suzuki, Kariya-shi (JP); Yukihiro Yamamoto, Kiriya-shi (JP); Shinji Ichikawa, Toyota-shi (JP); Toru Nakamura, Toyota-shi (JP)

(72) Inventors: Kazuyoshi Takada, Kariya-shi (JP); Shimpei Sakoda, Kariya-shi (JP); Sadanori Suzuki, Kariya-shi (JP); Yukihiro Yamamoto, Kiriya-shi (JP); Shinji Ichikawa, Toyota-shi (JP); Toru Nakamura, Toyota-shi (JP)

(73) Assignees: Toyota Jidosha Kabushiki Kaisha, Aichi-ken (JP); Kabushiki Kaisha Toyota Jidoshokki, Aichi-Ken (JP)

(21) Appl. No.: 13/811,529

(22) PCT Filed: Jul. 28, 2011
(86) PCT No.: PCT/JP2011/004283

§ 371 Date: Jan. 22, 2013

(30) Foreign Application Priority Data
Jul. 29, 2010 (JP) 2010-170592

(51) Int. Cl. H04B 5/00

(52) U.S. Cl. CPC H04B 5/0037
USPC 307/104

(57) ABSTRACT

A power supplying equipment includes an alternating-current power source and a primary-side resonance coil. A movable body equipment includes a secondary-side resonance coil a rectifier, and a secondary battery to which the power rectified by the rectifier is supplied. The power supplying equipment further includes a primary matching unit provided between the alternating-current power source and the primary-side resonance coil, and a primary matching unit adjusting section for adjusting the primary matching unit. The primary matching unit adjusting section adjusts the primary matching unit only at times other than when detecting the distance between the primary-side resonance coil and the secondary-side resonance coil.

### TECHNICAL FIELD

The present invention relates to a resonance type non-contact power supply system. More specifically, the present invention pertains to a resonance type non-contact power supply system that performs non-contact power supply from power supplying equipment to movable body equipment having a secondary battery.

### BACKGROUND ART

Japanese Laid-Open Patent Publication No. 2009-106136 proposes a charging system in which a vehicle mounted electrical storage device is charged by a power source outside the vehicle through wireless reception of charging power through a resonance method. Specifically, the charging system of the above document includes an electric vehicle and a power supply device. The electric vehicle has a secondary self-resonance coil, which is a secondary-side resonance coil, a secondary coil, a rectifier, and an electrical storage device. The power supply device has a high-frequency power driver, a primary coil, and a primary self-resonance coil, which is a primary-side resonance coil. The number of turns of the secondary self-resonance coil is determined based on the voltage of the electrical storage device, the distance between the primary self-resonance coil and the secondary self-resonance coil, and the resonant frequency of the primary self-resonance coil and the secondary self-resonance coil. The distance between the power supply device and the vehicle changes depending on the conditions of the vehicle, for example, the loading state and the tire air pressure. Changes in the distance between the primary self-resonance coil of the power supply device and the secondary self-resonance coil of the vehicle change the resonant frequency of the primary self-resonance coil and the secondary self-resonance coil. Therefore, in the electric vehicle of the above document, a variable capacitor is connected between the ends of the wire forming the secondary self-resonance coil. When charging the electrical storage device, the charging system of the above document calculates the charging power of the electrical storage device based on the detected values of a voltage sensor and a current sensor. The above document discloses that the charging system adjusts the LC resonant frequency of the secondary self-resonance coil by adjusting the capacity of the variable capacitor connected to the secondary self-resonance coil such that the charging power is maximized.

As described above, an objective of the power supplying method disclosed in the above document is to efficiently supply power from the power supplying section to the power receiving section even if the distance between the primary self-resonance coil and the secondary self-resonance coil is changed depending on the conditions of the vehicle, for example, the loading state and the tire air pressure. The power supplying method therefore adjusts the capacity of the variable capacitor of the secondary self-resonance coil when charging the electrical storage device such that the charging power of the electrical storage device is maximized. However, such a power supplying method requires calculating the charging power of the electrical storage device based on the detected values of the voltage sensor and the current sensor, and adjusting the capacity of the variable capacitor until the charging power is maximized.

The power supplying method is carried out on the assumption that, with the vehicle parked at a proper charging position, the distance between the primary self-resonance coil and the secondary self-resonance coil has been changed depending on the conditions of the vehicle, for example, the loading state and tire air pressure. Therefore, the above document does not disclose any configuration for detecting the distance between the resonance coil of the power supplying section and the resonance coil of the power receiving section to stop the vehicle at the predetermined charging position.

The charging system can detect the distance between the resonance coil of the power supplying section and the resonance coil of the power receiving section by measuring the input impedance of the resonance system. If the distance between the resonance coil of the power supplying section and the resonance coil of the power receiving section can be detected, the charging system can easily achieve a state in which power is efficiently supplied from the power supplying section to the power receiving section, by finely adjusting the matching unit.

### CITATION LIST

### Patent Literature

PTL 1: Japanese Laid-Open Patent Publication No. 2009-106136

### SUMMARY OF INVENTION

### Technical Problem

Accordingly, it is an objective of the present invention to provide a resonance type non-contact power supply system that is capable of accurately detecting the distance between a resonance coil of a power supplying section and a resonance coil of a power receiving section on the side of the power supplying section even if the power supplying section does not include a matching unit.

### Solution to Problem

To achieve the foregoing objective and in accordance with one aspect of the present invention, a resonance type non-contact power supply system includes power supplying equipment and movable body equipment. The power supplying equipment includes an alternating-current power source and a primary-side resonance coil for receiving power from the alternating-current power source. The movable body equipment includes a secondary-side resonance coil for receiving power from the primary-side resonance coil, a rectifier for rectifying the power received by the secondary-side resonance coil, and a secondary battery, to which the power rectified by the rectifier is supplied. The movable body equipment further includes a first matching unit between the alternating-current power source and the primary-side resonance coil, and the primary matching unit adjusting section for adjusting the first matching unit. The primary matching unit adjusting section is configured to adjust the primary matching unit only at times other than when detecting the distance between the primary-side resonance coil and the secondary-side resonance coil.

With this structure, the power supplying equipment can detect the distance between the primary-side resonance coil and the secondary-side resonance coil. During detection of distance, the primary matching unit adjusting section does not adjust the primary matching unit. For efficiently supplying power from the power supplying equipment to the movable body equipment, the distance between the primary-side resonance coil and the secondary-side resonance coil needs to be adequate. When detecting the distance between the primary-side resonance coil and the secondary-side resonance coil, the power supplying equipment measures, for example, the input impedance of the resonance system to detect the distance. The <input impedance of the resonance system> refers to the impedance of the entire resonance system (including the primary coil and the secondary coil) measured at both ends of the input coil to which alternating-current is supplied when the distance is detected. If the primary matching unit is adjusted when the input impedance of the resonance system is measured, the distance cannot be accurately detected based on the value of the impedance. However, according to the present invention, the primary matching unit is not adjusted when the distance is detected. This allows the distance to be accurately detected.

The movable body equipment preferably further comprises a charger between the rectifier and the secondary battery. The power rectified by the rectifier can be supplied to the charger, which can be connected to the secondary battery.

Other aspects and advantages of the invention will become apparent from the following description, taken in conjunction with the accompanying drawings, illustrating by way of example the principles of the invention.

The features of the present invention that are believed to be novel are set forth with particularity in the appended claims. The invention, together with objects and advantages thereof, may best be understood by reference to the following description of the presently preferred embodiments together with the accompanying drawings in which:

### BRIEF DESCRIPTION OF DRAWINGS

FIG. 1 is a diagram showing a resonance type non-contact power supply system according to one embodiment;

FIG. 2 is a circuit diagram that omits part of the resonance type non-contact power supply system of FIG. 1; and

FIG. 3 is an explanatory flowchart showing operation of the resonance type non-contact power supply system of FIG. 1.

### DESCRIPTION OF EMBODIMENTS

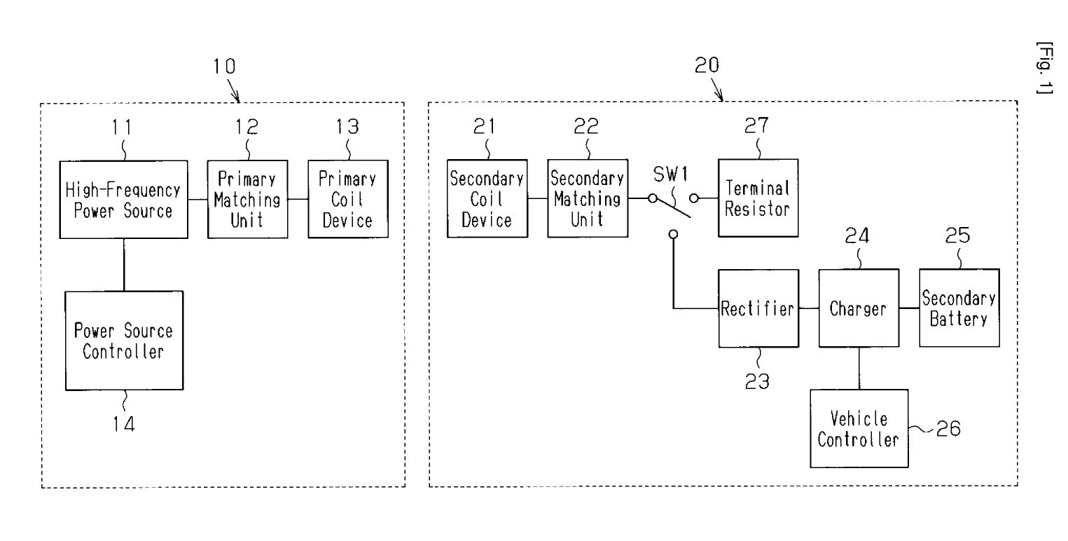

FIG. 1 shows a resonance type non-contact power supply system according to one embodiment of the present invention. The resonance type non-contact power supply system charges a vehicle mounted battery.

In FIG. 1, the resonance type non-contact power supply system includes power supplying equipment 10 and movable body equipment 20. The power supplying equipment 10 is power supplying equipment (power transmission equipment) provided on the ground. The movable body equipment 20 is power receiving equipment mounted on a movable body, which is a vehicle (automobile) in the first embodiment.

The power supplying equipment 10 is power supplying equipment, which includes a high-frequency power source 11 serving as an alternating-current power source, a primary matching unit 12, a primary coil device 13, and a power source controller 14. An alternating-current power source, which is the high-frequency power source 11 in this embodiment, receives a power ON/OFF signal from a power source-side controller, which is the power source controller 14 in this embodiment, so as to be turned on or off. The high-frequency power source 11 outputs alternating-current power the frequency of which is equal to a predetermined resonant frequency of the resonance system, for example, a high-frequency power of several MHz.

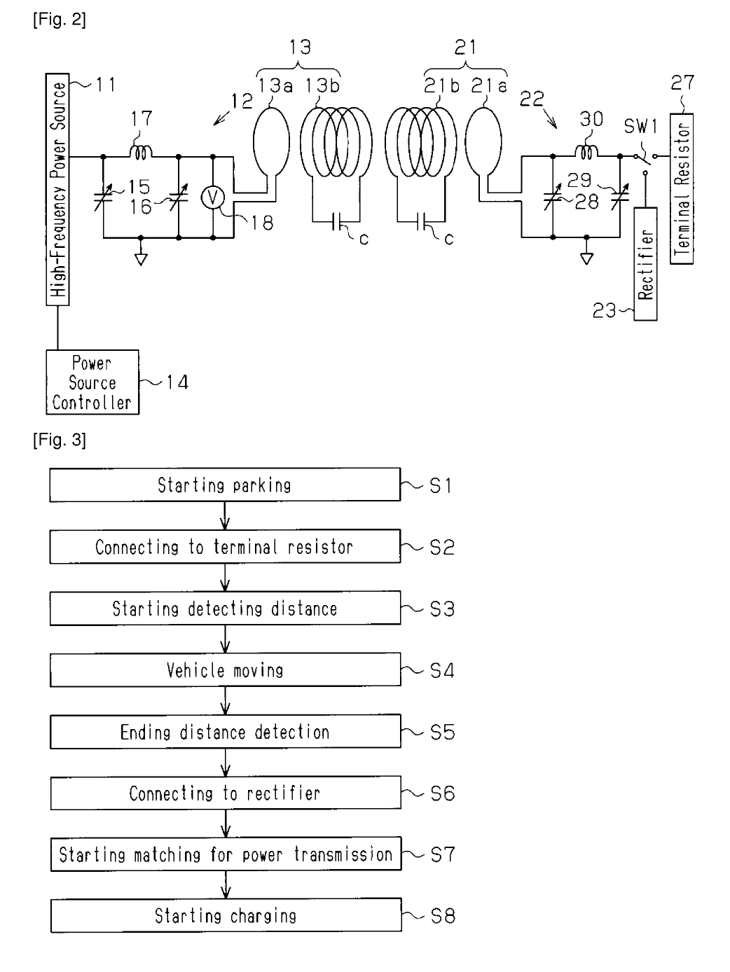

As shown in FIG. 2, the primary coil device 13 serving as a primary-side coil includes a primary coil 13a and a primary-side resonance coil 13b. The primary coil 13a is connected to the high-frequency power source 11 via the primary matching unit 12. The primary coil 13a and the primary-side resonance coil 13b are arranged to be coaxial. A capacitor C is connected in parallel to the primary-side resonance coil 13b. The primary coil 13a is coupled to the primary-side resonance coil 13b through electromagnetic induction. The alternating-current power supplied to the primary coil 13a from the high-frequency power source 11 is supplied to the primary-side resonance coil 13b through electromagnetic induction.

As shown in FIG. 2, the primary matching unit 12 includes two primary variable capacitors 15, 16, which serve as a variable reactance, and a primary inductor 17. One primary variable capacitor 15 is connected to the high-frequency power source 11. The other primary variable capacitor 16 is connected in parallel to the primary coil 13a. The inductor 17 is connected between the primary variable capacitors 15, 16. Changing the capacity of the primary variable capacitors 15, 16 changes the impedance of the primary matching unit 12. The primary variable capacitors 15, 16 have a known structure, which includes a rotary shaft (not shown) driven by, for example, a motor. When the motor is driven in accordance with a drive signal from the power source controller 14, the capacity of each of the primary variable capacitors 15, 16 is changed. That is, the power source controller 14 functions as a primary matching unit adjusting section (primary matching unit adjusting means) that adjusts the primary matching unit 12.

A voltage sensor 18 serving as an input impedance measuring section (input impedance measuring means) is connected in parallel to the primary coil 13a.

The power source controller 14 includes a CPU and a memory. The memory stores, as a map or a relational expression, data representing the relationship of the distance between the primary-side resonance coil 13b and the secondary-side resonance coil 21b with respect to the input impedance of the resonance system at the time when the high-frequency power source 11 outputs an alternating current of a predetermined frequency. The data is obtained through experiments in advance. When detecting distance, the power source controller 14 uses the voltage sensor 18 to detect the voltage at both ends of the primary coil 13a serving as an input coil, thereby measuring the input impedance. The CPU calculates the distance between the primary-side resonance coil 13b and the secondary-side resonance coil 21b based on the detected input impedance and the map or the relational expression. The power source controller 14 functions as a distance calculating section (distance calculating means). The power source controller 14 and the voltage sensor 18 form a distance detecting section.

The power source controller 14 adjusts the primary matching unit 12 only at times other than when detecting the distance between the primary-side resonance coil 13b and the secondary-side resonance coil 21b. That is, the power source controller 14 does not adjust the primary matching unit 12 during detection of the distance between the primary-side resonance coil 13b and the secondary-side resonance coil 21b.

As shown in FIG. 1, the movable body equipment 20 includes a secondary coil device 21, a secondary matching unit 22, a rectifier 23, a charger 24, a secondary battery 25, a vehicle controller 26, and a terminal resistor 27. The charger 24 is connected to the rectifier 23, the secondary battery 25, and the vehicle controller 26. The secondary matching unit 22 is switched between a state in which the secondary matching unit 22 is connected to the terminal resistor 27 via a switch SW1, and a state in which the secondary matching unit 22 is connected to the rectifier 23 via the switch SW1.

As shown in FIG. 2, the secondary coil device 21 is a secondary-side coil formed by a secondary coil 21a and a secondary-side resonance coil 21b. The secondary coil 21a and the secondary-side resonance coil 21b are arranged to be coaxial. A capacitor C that is different from the one connected to the primary-side resonance coil 13b is connected to the secondary-side resonance coil 21b. The secondary coil 21a is coupled to the secondary-side resonance coil 21b through electromagnetic induction. That is, the alternating-current power supplied to the secondary-side resonance coil 21b from the primary-side resonance coil 13b through resonance is supplied to the secondary coil 21a by electromagnetic induction. The secondary coil 21a is connected to the secondary matching unit 22.

As shown in FIG. 2, the secondary matching unit 22 includes two secondary variable capacitors 28, 29, which serve as a variable reactance, and an inductor 30. One secondary variable capacitor 28 is connected in parallel to the secondary coil 21a. The other secondary variable capacitor 29 is selectively connected to one of the terminal resistor 27 and the rectifier 23 via the switch SW1. Changing the capacity of the secondary variable capacitors 28, 29 changes the impedance of the secondary matching unit 22. The secondary variable capacitors 28, 29 have a known structure, which includes a rotary shaft (not shown) driven by, for example, a motor. When the motor is driven in accordance with a drive signal from the vehicle controller 26, the capacity of each of the secondary variable capacitors 28, 29 is changed.

The charger 24 shown in FIG. 1 includes a DC/DC converter (not shown), which converts direct-current rectified by the rectifier 23 to a voltage suitable for charging the secondary battery 25. The vehicle controller 26 controls a switching element of the DC/DC converter of the charger 24 when performing charging.

The number of turns and the winding diameter of the primary coil 13a, the primary-side resonance coil 13b, the secondary-side resonance coil 21b, and the secondary coil 21a are set as required in accordance with the magnitude of power supplied (transmitted) from the power supplying equipment 10 to the movable body equipment 20. The switch SW1 represents a change-over contact of a relay. FIGS. 1 and 2 show the change-over contact of the relay as a contact relay. However, for example, the change-over contact of the switch SW1 may be formed by a non-contact relay using a semiconductor element.

The power source controller 14 and the vehicle controller 26 communicate with each other via a non-illustrated wireless communication device. From when the vehicle is stopped (parked) at a predetermined charging position of the power supplying equipment 10 until when charging is finished, the power source controller 14 and the vehicle controller 26 transmit and receive necessary information with each other. The vehicle has an indicating device (not shown). When the distance between the primary-side resonance coil 13b and the secondary-side resonance coil 21b detected by the power supplying equipment 10 becomes equal to an adequate distance for allowing the power supplying equipment 10 to efficiently supply power without making contact therewith, the indicating device indicates to the driver of the vehicle that the detected distance has become equal to the adequate distance. The indicating device preferably has a display, which can be visually checked by the driver and shows the state of displacement from such an adequate distance. However, the indicating device may be a device that generates sound that may be aurally monitored by the driver. When the vehicle is parked at the charging position, the vehicle controller 26 activates the indicating device based on the distance information sent from the power source controller 14.

The vehicle controller 26, which serves as a control device, controls the switch SW1. Specifically, the vehicle control 26 connects the secondary matching unit 22 and the terminal resistor 27 with each other via the switch SW1 when the power supplying equipment 10 detects the distance between the primary-side resonance coil 13b and the secondary-side resonance coil 21b. When detection of distance by the power source controller 14 is ended, the vehicle controller 26 connects the secondary matching unit 22 and the rectifier 23 with each other via the switch SW1.

### Operation

Operation of the resonance type non-contact power supply system configured as described above will now be described.

When the secondary battery 25 mounted on the vehicle is charged by the power supplying equipment 10, the vehicle needs to be parked (stopped) at the charging position where the distance between the secondary-side resonance coil 21b and the primary-side resonance coil 13b is equal to a predetermined distance. Therefore, prior to power supply from the power supplying equipment 10 to the charger 24 of the movable body equipment 20, the power supplying equipment 10 detects, using the power source controller 14, the distance between the secondary-side resonance coil 21b and the primary-side resonance coil 13b. The information of the detected distance is sent to the vehicle controller 26 from the power source controller 14. After the vehicle is moved to the parking position based on the distance information, charging of the secondary battery 25 is started.

That is, as shown in FIG. 3, parking is started at step S1. At step S2, the vehicle controller 26 switches the switch SW1 to connect the secondary matching unit 22 and the terminal resistor 27 to each other, and sends to the power source controller 14 a signal indicating that the switch SW1 has been switched. When notified that the terminal resistor 27 is connected to the secondary matching unit 22, the power source controller 14 starts, at step S3, detecting the distance between the primary-side resonance coil 13b and the secondary-side resonance coil 21b.

When the high-frequency power source 11 is outputting alternating-current power of a predetermined frequency, the power source controller 14 calculates the input impedance of the primary coil 13a based on the detection signal of the voltage sensor 18, and detects (calculates) the distance between the primary-side resonance coil 13b and the secondary-side resonance coil 21b based on the value of the input impedance and the map or the relational expression. The power source controller 14 sends the in-formation of the detected distance to the vehicle controller 26.

While the vehicle is moving, the vehicle controller 26 activates the indicating device based on comparison between the information of the detected distance sent from the power source controller 14 and the adequate distance for efficiently receiving non-contact power supply from the power supplying equipment 10. Based on the indication from the indicating device, the driver of the vehicle stops the vehicle when the vehicle reaches a position for efficiently receiving non-contact power supply from the power supplying equipment 10. That is, at step S4, the vehicle is moved to a predetermined parking position based on the distance information received by the vehicle controller 26. When the vehicle reaches the parking position at step S5, the power source controller 14 ends the distance detection and sends a signal indicating the end of the distance detection to the vehicle controller 26. When notified that the distance detection by the power source controller 14 has ended, the vehicle controller 26 switches the switch SW1 at step S6 to connect the secondary matching unit 22 and the rectifier 23 to each other, and sends a signal indicating the switching of the switch SW1 to the power source controller 14. From when the parking is started until when step S6 is complete, the primary matching unit 12 and the secondary matching unit 22 are held in a stopped state, and are not adjusted.

Subsequently, at step S7, matching for power transmission is executed prior to charging. That is, with the vehicle parked at the parking position, the power source controller 14 and the vehicle controller 26 control the primary matching unit 12 and the secondary matching unit 22, respectively, such that the resonance state of the resonance system is optimized. Thereafter, charging is started at step S8.

Then, the high-frequency power source 11 of the power supplying equipment 10 applies an alternating voltage of the resonant frequency to the primary coil 13a, so that power is supplied from the primary-side resonance coil 13b to the secondary-side resonance coil 21b through non-contact resonance. The power received by the secondary-side resonance coil 21b is supplied to the charger 24 via the secondary matching unit 22 and the rectifier 23. Thus, the secondary battery 25 connected to the charger 24 is charged. As the charging state of the secondary battery 25 changes after charging starts, the impedance of the secondary coil device 21 changes, and the impedance of the resonance system is shifted from an adequate value. Based on a map or a relational expression representing the relationship between the charging state of the secondary battery 25 and an adequate impedance of the secondary coil device 21 that corresponds to the charging state stored in the memory, the vehicle controller 26 adjusts the secondary matching unit 22 such that the impedance of the secondary coil device 21 becomes adequate for the charging state. Accordingly, the secondary battery 25 is charged in an adequate state. The vehicle controller 26 determines that charging has been completed based on, for example, the elapsed time from when the voltage of the secondary battery 25 has become equal to a predetermined voltage. When charging of the secondary battery 25 is completed, the vehicle controller 26 transmits a charging completion signal to the power source controller 14. The power source controller 14 stops the power transmission when receiving the charging completion signal.

The present embodiment has the following advantages.

(1) The resonance type non-contact power supply system includes the power supplying equipment 10 and the movable body equipment 20. The power supplying equipment 10 includes the alternating-current power source, which is the high-frequency power source 11 in the first embodiment, and the primary-side resonance coil 13b, which receives power from the alternating-current power source. The movable body equipment 20 receives power from the power supplying equipment 10 without contact. The movable body equipment 20 includes the secondary-side resonance coil 21b, which receives power from the primary-side resonance coil 13b, the rectifier 23, which rectifies the power supplied to the secondary-side resonance coil 21b, the charger 24, which receives the power that has been rectified by the rectifier 23, and the secondary battery 25 connected to the charger 24. The power supplying equipment 10 includes the primary matching unit 12 provided between the alternating-current power source and the primary-side resonance coil 13b, and the primary matching unit adjusting section (the power source controller 14) for adjusting the primary matching unit. The primary matching unit adjusting section (the primary matching unit adjusting means) adjusts the primary matching unit 12 only at times other than when detecting the distance between the primary-side resonance coil 13b and the secondary-side resonance coil 21b. Thus, the primary matching unit 12 is not adjusted during detection of distance. This stabilizes the input impedance of the resonance system, and therefore allows accurate distance detection to be performed.

(2) The movable body equipment 20 includes the secondary matching unit 22, the switch SW1, and the terminal resistor 27, which is connectable to the secondary matching unit 22 via the switch SW1. When the power supplying equipment 10 detects the distance between the primary-side resonance coil 13b and the secondary-side resonance coil 21b, the switch SW1 is switched to the state in which it connects the secondary matching unit 22 to the terminal resistor 27. Therefore, when the power supplying equipment 10 detects the input impedance of the resonance system to detect distance, the detection accuracy of the input impedance of the resonance system is improved. Also, reflection of the power, which is supplied from the alternating-current power source to the resonance system and to the movable body equipment 20, is reduced. This improves the detection accuracy of the impedance.

(3) When parking for charging is performed, the vehicle is moved to a predetermined parking position based on the information of the distance between the primary-side resonance coil 13b and the secondary-side resonance coil 21b detected by the power supplying equipment 10. Thus, after the vehicle is parked, the primary matching unit 12 and the secondary matching unit 22 can be easily adjusted to put the resonance system into an adequate state for starting of charging.

(4) The vehicle on which the movable body equipment 20 is mounted has the indicating device. When the distance between the primary-side resonance coil 13b and the secondary-side resonance coil 21b detected by the power supplying equipment 10 has become equal to an adequate distance for allowing the power supplying equipment 10 to efficiently supply power without making contact therewith, the indicating device indicates that the detected distance becomes the adequate distance. This allows the vehicle to be easily moved to the charging position and parked.

The present invention is not restricted to the illustrated embodiments but may be embodied according to the following modifications.

In order to be able to perform non-contact power supply between the power supplying equipment 10 and the movable body equipment 20, the resonance type non-contact power supply system does not necessarily include all of the primary coil 13a, the primary-side resonance coil 13b, the secondary coil 21a, and the secondary-side resonance coil 21b. The power supply system only needs to have at least the primary-side resonance coil 13b and the secondary-side resonance coil 21b. That is, instead of forming the primary coil device 13 by the primary coil 13a and the primary-side resonance coil 13b, the primary-side resonance coil 13b may be connected to the high-frequency power source 11 via the primary matching unit 12. That is, the primary coil 13a may be omitted. Also, instead of forming the secondary coil device 21 by the secondary coil 21a and the secondary-side resonance coil 21b, the secondary-side resonance coil 21b may be connected to the rectifier 23 via the secondary matching unit 22. That is, the secondary coil 21a may be omitted. However, a configuration with all of the primary coil 13a, the primary-side resonance coil 13b, the secondary coil 21a, and the secondary-side resonance coil 21b can easily achieve a resonance state, and easily maintain a resonance state even if the distance between the primary-side resonance coil 13b and the secondary-side resonance coil 21b is great.

In a case where the primary coil 13a is omitted, the voltage sensor 18, which forms a distance detecting section, measures the voltage between the ends of the primary-side resonance coil 13b serving as an input coil. Then, the power source controller 14 detects the distance between the primary-side resonance coil 13b and the secondary-side resonance coil 21b from a map or a relational expression representing the relationship between the value of the measured voltage and the distance between the primary-side resonance coil 13b and the secondary-side resonance coil 21b.

The secondary matching unit 22 of the movable body equipment 20 may be omitted. However, with the secondary matching unit 22, the impedance of the resonance system can be more finely adjusted, so that power is more efficiently supplied from the supplying side to the receiving side.

A vehicle serving as the movable body is not limited to a type that requires a driver, but may be an unmanned carrier.

The movable body is not limited to a vehicle, but may be a robot. In a case where the movable body is a robot, the movable body equipment 20 has a control device. When the robot is stopped at a predetermined charging position, the control device stops, based on data of the distance detected by the power supplying equipment, the robot such that the distance between the primary-side resonance coil 13b and the secondary-side resonance coil 21b becomes equal to an adequate distance for allowing the power supplying equipment 10 to efficiently supply power without making contact therewith.

The primary matching unit 12 and the secondary matching unit 22 do not need to be of pi-type, but may be T-type or L-type matching units.

Each of the primary matching unit 12 and the secondary matching unit 22 does not need to include two variable capacitors and an inductor. Each of the primary matching unit 12 and the secondary matching unit 22 may have a structure including a variable inductor as the inductor, or a structure including a variable inductor and two non-variable capacitors.

The high-frequency power source 11 may be configured such that the frequency of the output alternating-current voltage is variable or invariable.

The charger 24 does not need to have a booster circuit. For example, the charger 24 may be configured to charge the secondary battery 25 with an alternating current output by the secondary coil device 21 after only being rectified through the rectifier 23.

The charger 24 may be omitted from the movable body equipment 20. In this case, the power rectified by the rectifier 23 can be supplied directly to the secondary battery 25. Whether the charger 24 is omitted or not, the power supplying equipment 10 may be configured to adjust the output power of the high-frequency power source 11.

The diameter of the primary coil 13a and the diameter of the secondary coil 21a are not limited to being equal to the diameter of the primary-side resonance coil 13b and the diameter of the secondary-side resonance coil 21b, respectively, but may be smaller or greater than the diameter of the primary-side resonance coil 13b and the diameter of the secondary-side resonance coil 21b.

The primary-side resonance coil 13b and the secondary-side resonance coil 21b are not limited to being formed by a wire wound into a helical shape, but may be formed by a wire wound into a spiral shape on a plane.

The capacitors C connected to the primary-side resonance coil 13b and the secondary-side resonance coil 21b may be omitted. However, a configuration with capacitors C connected to the primary-side resonance coil 13b and the secondary-side resonance coil 21b lowers the resonant frequency compared to a configuration without capacitors C. If the resonant frequency is the same, the size of the primary-side resonance coil 13b and the secondary-side resonance coil 21b can be reduced with the structure in which the capacitors C are connected to the primary-side resonance coil 13b and the secondary-side resonance coil 21b, compared to a case where the capacitors C are omitted.

1. A resonance type non-contact power supply system comprising:
power supplying equipment including an alternating-current power source and a primary-side resonance coil for receiving power from the alternating-current power source; and
movable body equipment including a secondary-side resonance coil for receiving power from the primary-side resonance coil, a rectifier for rectifying the power received by the secondary-side resonance coil, and a secondary battery to which the power rectified by the rectifier is supplied, and
wherein:
the power supplying equipment includes a primary matching unit provided between the alternating-current power source and the primary-side resonance coil, and a primary matching unit adjusting section for adjusting the primary matching unit, and
the primary matching unit adjusting section is configured to adjust the primary matching unit only at times other than when detecting the distance between the primary-side resonance coil and the secondary-side resonance coil.

2. The resonance type non-contact power supply system according to claim 1, wherein
the movable body equipment includes a secondary matching unit, a switch, and a terminal resistor, which is connectable to the secondary matching unit via the switch,
when the distance between the primary-side resonance coil and the secondary-side resonance coil is detected at the power supplying equipment, the switch is switched to a state in which the switch connects the secondary matching unit to the terminal resistor.

3. The resonance type non-contact power supply system according to claim 1, wherein the power supplying equipment includes:
an input impedance detecting section, which detects input impedance of a resonance system when alternating-current power is output from the alternating-current power source; and
a distance calculating section, which calculates the distance between the primary-side resonance coil and the secondary-side resonance coil based on a relationship of the distance between the primary-side resonance coil and the secondary-side resonance coil with respect to the input impedance of the resonance system.

4. The resonance type non-contact power supply system according to claim 1, wherein the movable body equipment is mounted on a vehicle.

5. The resonance type non-contact power supply system according to claim 4, wherein
the vehicle has an indicating device, and
when a distance detected by the power supplying equipment becomes equal to an adequate distance for allowing the power supplying equipment to efficiently supply power without making contact therewith, the indicating device indicates that the detected distance has become equal to the adequate distance.

6. The resonance type non-contact power supply system according to claim 1, wherein
the movable body has a control device, and
when the movable body is stopped at a predetermined charging position, the control device stops, based on data of the distance detected by the power supplying equipment, the movable body such that the distance between the primary-side resonance coil and the secondary-side resonance coil becomes equal to an adequate distance for allowing the power supplying equipment to efficiently supply power without making contact therewith.

7. The resonance type non-contact power supply system according to claim 1, wherein the movable body equipment further comprises a charger provided between the rectifier and the secondary battery, the power rectified by the rectifier is supplied to the charger, and the secondary battery is connected to the charger.
